(19) United States
(12) Patent Application Publication
(10) Pub. No.: US 2008/0307481 A1
(43) Pub. Date: Dec. 11, 2008

(54) Method and System for Managing Content in a Network

(75) Inventor: Krishna Prasad Panje, Bangalore (IN)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 12/133,839

(22) Filed: Jun. 5, 2008

(30) Foreign Application Priority Data
Jun. 8, 2007 (IN) 1239/DEL/2007

(51) Int. Cl. H04N 7/173

(52) U.S. Cl. 725/119

(57) ABSTRACT

A method and a system for managing content in a network are disclosed. The network includes a content server (104). The method includes receiving (304) the base content of the content. The base content includes information that is independent of a user profile. Further, the method includes modifying (306) the content, based on the dynamic content of the content, the base content and the user profile.

### FIELD OF THE INVENTION

This invention relates in general to the networks, and more specifically, to a method and system for managing content in a network.

### BACKGROUND OF THE INVENTION

Networks have become increasingly important with the increased need for communication and information exchange. Networks enable distribution of content to a variety of users. Examples of content can be a commercial message, an advertisement, trade-related information, current program information, future program information, a display logo, a subtitle, audio information, a channel logo, a ticker, and a flash display. Content can be distributed and broadcasted globally. For example, content created at a particular location or region can be distributed across various locations worldwide. Further, the same content can be distributed at different demographics, which can be provided to users with different interests, based on the culture, language and viewer background of a particular demography. Some portions of the content may not be effective or of interest to users at different demographics. For example, content priced in dollars may not be effective in India, where the currency is rupees. The possibility and requirement of distributing one single content across different demographics has resulted in the need for content management.

There exist various methods to manage content, based on users' preferences. One such known method includes tracking the content-watching patterns and searching habits of users. A user profile is created, based on the information being tracked. This user profile is then used to provide specific content to the user. However, in this method, new content needs to be created, based on a user profile. As a result, the overall cost and time for delivering content is increased.

Therefore, there exists a need for a method and system for managing content in a network. The method should be able to manage content for effective distribution. Further, the content should be of interest to users.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments and explain various principles and advantages, all in accordance with the present invention.

FIG. 1 illustrates an exemplary network, where various embodiments of the present invention can be practiced;

FIG. 2 is a block diagram illustrating a content server, in accordance with one embodiment of the present invention;

FIG. 3 is a flowchart illustrating a method for managing content in a network, in accordance with one embodiment of the present invention;

FIG. 4 is a flowchart illustrating a method for managing content in a network, in accordance with another embodiment of the present invention; and

FIGS. 5 and 6 are a flowchart illustrating a method for managing content in a network, in accordance with yet another embodiment of the present invention.

Skilled artisans will appreciate that elements in the figures are illustrated for simplicity and clarity and have not necessarily been drawn to scale. For example, the dimensions of some of the elements in the figures may be exaggerated, relative to other elements, to help in improving an understanding of the embodiments of the present invention.

### DETAILED DESCRIPTION

Before describing in detail the particular method and system for managing content in a network, in accordance with various embodiments of the present invention, it should be observed that the present invention resides primarily in combinations of method steps related to the method and system for managing content in the network. Accordingly, the apparatus components and method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms “comprises,” “comprising”, or any other variation thereof, are intended to cover a non-exclusive inclusion, such that a process, method, article or apparatus that comprises a list of elements does not include only those elements but may include other elements that are not expressly listed or inherent in such a process, method, article or apparatus. An element proceeded by “comprises . . . a” does not, without more constraints, preclude the existence of additional identical elements in the process, method, article or apparatus that comprises the element. The term “another,” as used in this document, is defined as at least a second or more. The terms “includes” and/or “having”, as used herein, are defined as comprising

For one embodiment, the present invention provides a method for managing content in a network. The network includes a content server. The method at the content server includes receiving a base content of the content. The base content includes information that is independent of a user profile. Further, the method includes modifying the content, based on the dynamic content of the content, the base content and the user profile.

For another embodiment, the present invention provides a method for managing content in a network. The method includes a content server. The method at the content server includes receiving the content, which includes a base content and a dynamic content. Further, the method includes modifying the content, based on the dynamic content and the user profile.

For yet another embodiment, the present invention provides a content server for managing content in a network. This content server includes a receiving module, which is configured to receive content. Further, the content server includes a processing module, which is configured to modify the content, based on the dynamic content of the content and the user profile.

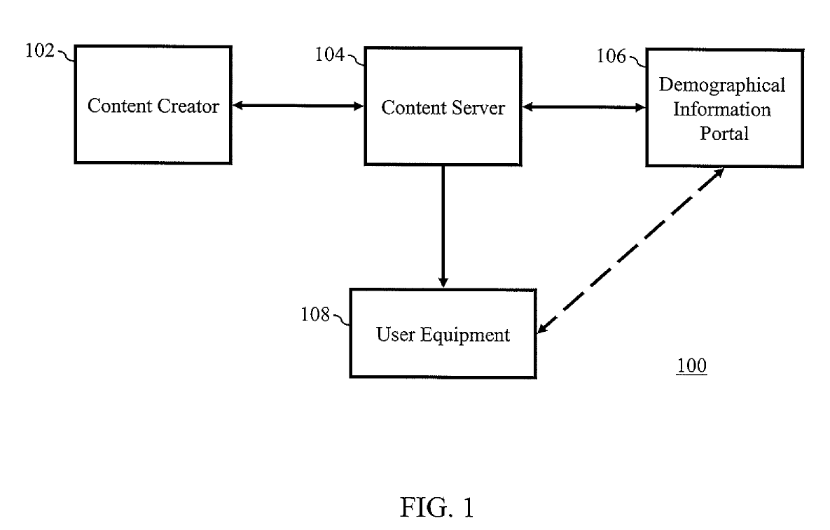

FIG. 1 illustrates an exemplary network 100, where various embodiments of the present invention can be practiced. For the purpose of this description, the network 100 is shown to include a content creator 102, a content server 104, a demographic information portal 106, and a user equipment 108. Examples of the network 100 include, but are not limited to, a television network, the Internet and a mobile network. The content creator 102 creates content that can be managed in the network 100. Examples of the content creator 102 can be a satellite channel, a movie studio, an advertisement creator, and a mobile service provider. Examples of the content can include a commercial message, an advertisement, trade-related information, current program information, future program information, a display logo, a subtitle, audio information, a channel logo, a ticker, and a flash display.

For the purpose of this description, the content includes a base content and a dynamic content. The base or core content is independent of different demographics or user profiles. The base content contains core information pertaining to the content. This core information is essential and is required every time the content is displayed. In other words, the base content cannot be modified. The dynamic content is dependent on different demographics or user profiles and contains information that is variable and is dependent on user profiles. For example, consider an advertisement for a particular brand of engine oil, with the advertisement including this particular engine oil, a luxury car in the background, and the price of the engine oil in dollars. Since the advertisement is for the engine oil, the base content of the advertisement includes the engine oil, which will be displayed at all times. In this example, the dynamic content includes the luxury car shown in the background and the price of the engine oil in dollars. The dynamic content can be changed for different demographics or user profiles. For example, the content can be modified if a user is located in Europe and is a rally-car driver. This modification is carried out by displaying a sports car in the place of the luxury car, and the price is displayed in euros in place of dollars. In one embodiment, the content can be modified in consultation with the content creator 102. For example, the content creator 102 may suggest displaying the price in euros in place of dollars.

The content creator 102 creates the content and sends it to the content server 104. Examples of the content server 104 include, but are not limited to, a satellite station, a broadcast station, a base station, a head-end device of a cable network such as set-top-box, and a radio station. The content server 104 modifies the content for a particular user profile or demography. In one example, the content server 104 modifies the content, based on the user profile. The user profile can be stored on a demographic information portal 106, which would provide the user profile to the content server 104 when required. In one embodiment, the user profile can be stored on a third party portal or a social networking site. The user profile is based on the preference, geographical location, age, sex, social network, community, religion, job sector, and historical data of the users. In one embodiment, the user profile is based on user activities such as searching or browsing the Internet and television-viewing habits. For example, the user profile can include websites that are frequently visited by the user. The content server 104 modifies the content, based on the user profile received from the demographic information portal 106, and provides it to the user equipment 108. Examples of the user equipment 108 can include a television, an Internet Protocol Television (IPTV), a computer, a set-top-box, a mobile phone, a music player, and a radio set.

Though the various embodiments will be explained in conjunction with a content server, a content creator and a demographic information portal, it will be apparent to a person ordinarily skilled in the art that the various functionalities associated with the content server, the content creator and the demographic information portal can be implemented by using a single server.

In accordance with another example, consider an advertisement for a toy that includes a cartoon character. This cartoon character may be popular in a particular demography but totally foreign in other demographics. Since the character can be changed for different demographics, it is dynamic content. The use of a local cartoon character results in users being more closely associated with the content. The toy must however be common across the demographics and convey the core information pertaining to the content.

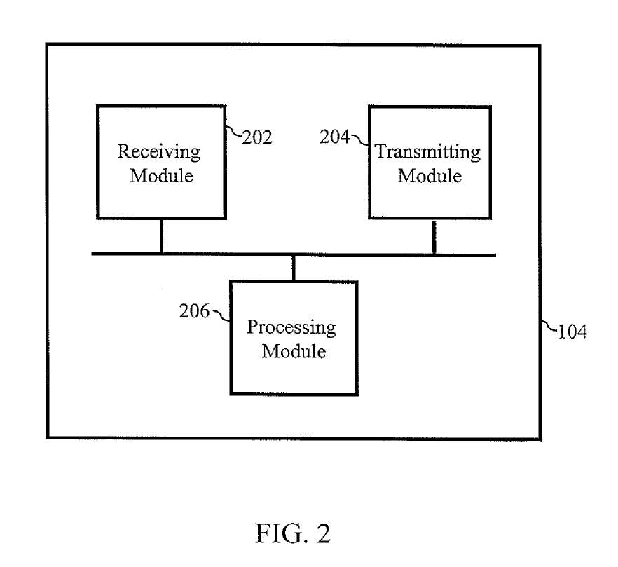

FIG. 2 is a block diagram illustrating the content server 104, in accordance with one embodiment of the present invention. For the purpose of description, the content server 104 is shown to include a receiving module 202, a transmitting module 204 and a processing module 206. The receiving module 202 receives the content being managed in the network 100. In one embodiment, the receiving module can also receive the attributes of the dynamic content from the content creator 102. In another embodiment, the receiving module 202 can receive a user profile from the demographic information portal 106 and send the content to the processing module 206. In one example, the processing module 206 identifies the dynamic content, based on the attributes of the dynamic content received by the receiving module 202. After the identification of the dynamic content, the processing module 206 modifies the dynamic content, based on the user profile and the base content. After the modifications, the processing module 206 sends the content to the transmitting module 204, which provides the modified content to the user equipment 108. In one embodiment, the transmitting module 204 also provides the attributes of the dynamic content to the demographic information portal 106.

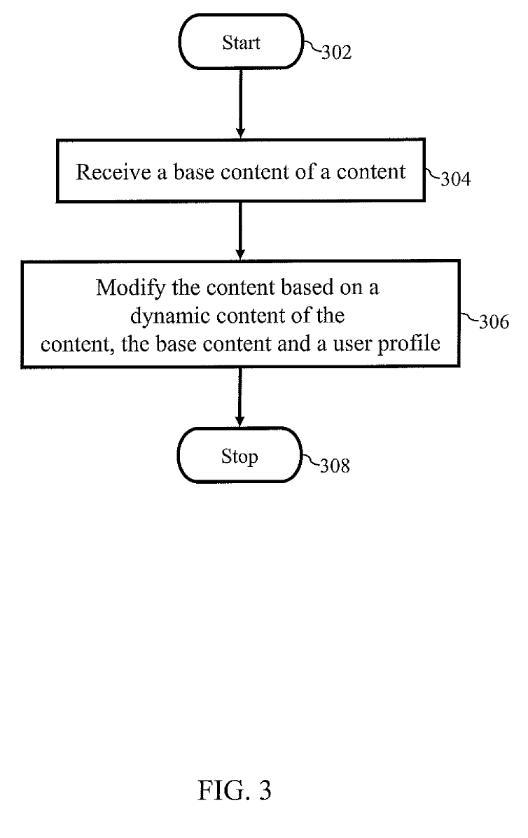

FIG. 3 is a flowchart illustrating the method for managing content in a network, in accordance with one embodiment of the present invention. The method for managing the content at the content server 104 is initiated at step 302. At step 304, the content server 104 receives the base content, which conveys the core information of the content. The base content is independent of user profile and does not vary across different demographics. Consider the example of a company selling burgers in the USA and India. In this case, the trademark or the logo of the company can be the base content of the advertisement, which is displayed in the USA as well as in India.

At step 306, the content server 104 modifies the content, based on the dynamic content, the base content and the user profile. In one example, the dynamic content depends on the user profile and is modified for different demographics. Modification of the content includes altering, adding, translating, deleting and converting the dynamic content. For example, a company selling burgers can have its range of burgers shown in an advertisement in the USA. The same advertisement, when shown in India, can be altered to include new varieties of burgers. Further, the commentary in the background of the advertisement can be translated into Hindi. Thereafter, the method for managing content in a network is terminated at step 308.

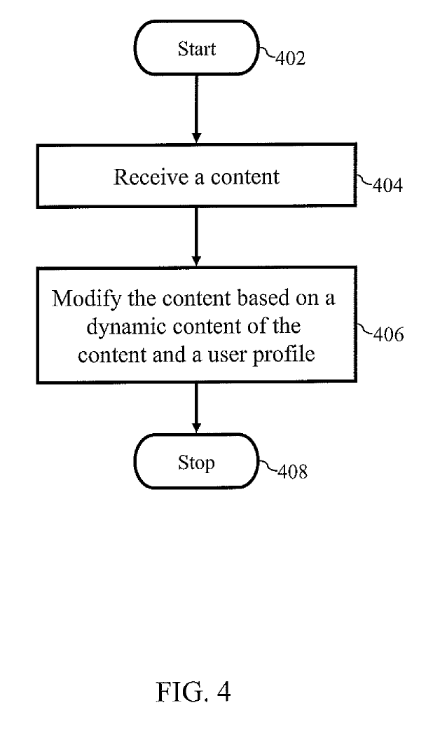

FIG. 4 is a flowchart illustrating the method for managing content in a network, in accordance with one embodiment of the present invention. The method for managing the content at the content server 104 is initiated at step 402. At step 404, the content server 104 receives the content, which includes the base content and the dynamic content. The content server 104 can identify the dynamic content, based on the attributes of the content. The base content is independent of the user profile, and the dynamic content is dependent on it. For example, an advertisement for a soft drink can include a cafeteria as its background. The soft drink is the base content of the advertisement and is independent of the user profile, while the background is the dynamic content of the advertisement and can be changed for different user profiles. At step 406, the content server 104 modifies the content, based on the dynamic content and the user profile. Modification of the content includes altering, adding, translating, deleting and converting the dynamic content. For example, the background in the advertisement of the soft drink can be changed to a baseball stadium when the user belongs to a baseball-loving nation or region. The background can be changed to a soccer stadium, when the user is a soccer enthusiast. The method for managing content in a network is terminated at step 408.

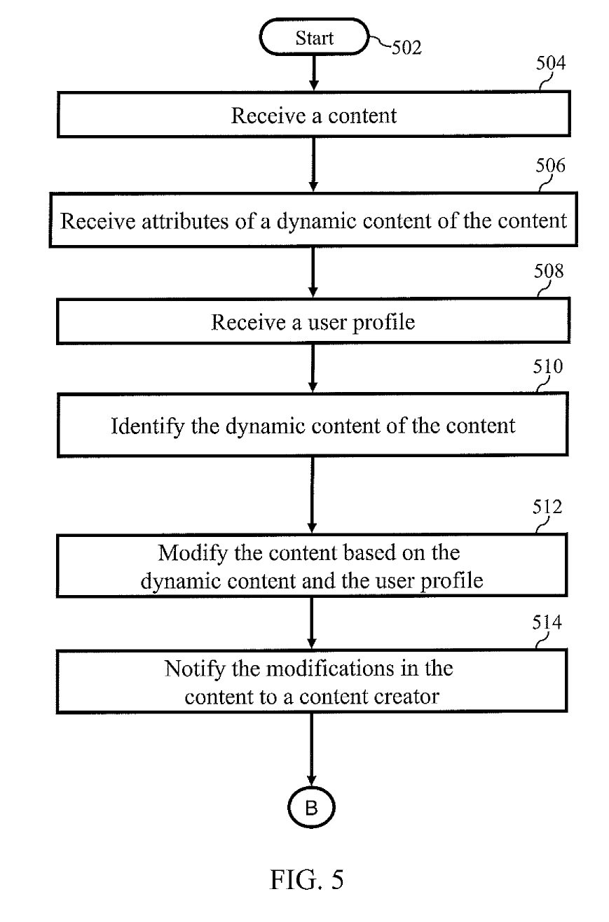

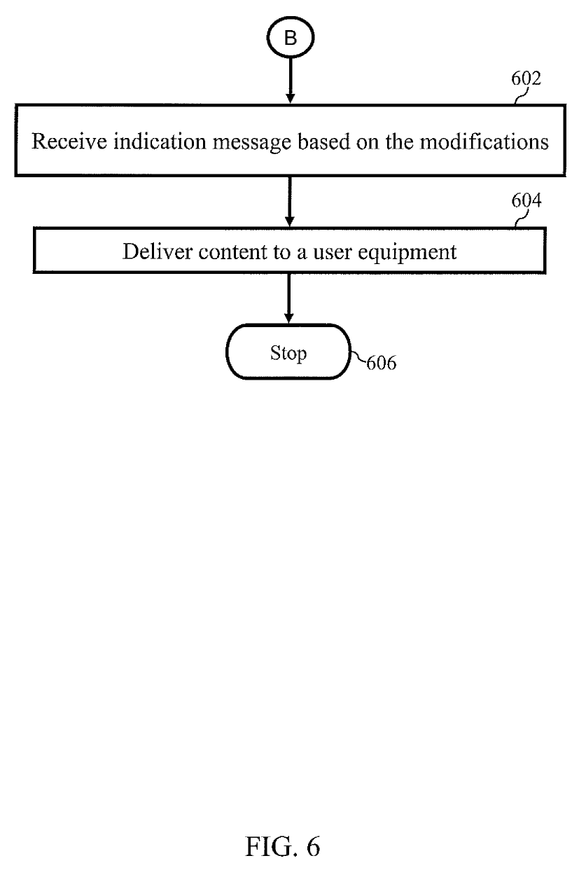

FIGS. 5 and 6 are a flowchart illustrating the method for managing content in a network, in accordance with one embodiment of the present invention. The method for managing the content is initiated at step 504. At step 504, the content server 104 receives the content from the content creator 102. The content includes base content. In another embodiment, the content includes the base content and the dynamic content.

For example, the content server 104 receives an advertisement describing a range of fashion products, which shows a popular film star. In this example, the range of fashion products can be the base content and the popular film star can be the dynamic content that can be changed or modified for different demographics.

At step 506, the content server 104 receives the attributes of the dynamic content, which are used to provide alternative objects corresponding to a particular attribute. For example, content falling under the category ‘car’ can have many attributes. For example, ‘make’ and ‘model’ can be two attributes that correspond to a car. The alternative, corresponding to the ‘make’ attribute, can be a car manufactured by company ‘Make1’ and a car manufactured by company ‘Make2’. Further, different alternatives corresponding to the ‘model’ attribute can be model ‘Model1’ and ‘Model2’ for company Make1, and model ‘Model3’ and ‘Model4’ for company Make2. The attributes also assist in the identification of dynamic content, as explained in step 510.

At step 508, the content server 104 receives a user profile, which can be received from multiple sources. For an example, a user profile can be received from the demographic information portal 106 or a social networking site.

At step 510, the content server 104 identifies the dynamic content. The dynamic content can be identified, based on at least one object, scene, attribute, frame coordinate, or a portion of the content. For example, MPEG-4 uses objects to represent aural, visual or audiovisual content. An object in a MPEG-4 file can be a ‘car’, which can also be identified by an identification tag ‘1234’. The object can have several attributes. For MPEG-4 these attributes can be part of object attributes. In case of MPEG-2 the attributes can be multiplexed with content metadata. Further, any multimedia content or object description language can be used to describe a content. The multimedia content or object description language can use techniques described in their standards to associate the attributes with the content. For example, the ‘car’ object can have ‘make’ and ‘model’ as its attributes. Further, each of the attributes corresponding to an object can be given identification tags. For example, an attribute ‘car.make’ can be identified by an identification tag ‘12341’, and another attribute ‘car.model’ can be given an identification tag, ‘12342’. In one example, the content server 104 identifies the dynamic content, based on the identification tags. In another example, the dynamic content is identified, based on the frame coordinates, scene or objects received by the content server 104. The content includes the frame, scene or objects corresponding to the dynamic content, and the corresponding frame number, scene information or object details are received by the content server 104.

In one embodiment, the content creator 102, the content server 104, and the demographic information portal 106 have a common identification tag corresponding to the dynamic content. For example, if the identification tag ‘1234’ is associated with an object ‘car’, ‘1234’ will represent a ‘car’ for each of the content creator 102, the content server 104 and the demographic information portal 106. Examples of a dynamic content can include a scene, or a portion in the content. In another example, the dynamic content can be identification tags or attributes corresponding to specific locations or objects in the content. For example, in an advertisement of a travel company the dynamic content can be frames, attributes or scene representing a location like ‘Paris’. The dynamic content can be identified by using frame coordinates, portion of the content or scene showing ‘Paris’. In another example, the travel tour company can provide separate clips of media content for different locations around the world. In one embodiment, the identification tag is multiplexed along with the base content. In another example, the identification tag can also be multiplexed with content metadata or an object. The dynamic content can therefore be identified by any one of the content creator 102, the content server 104 or the demographic information portal 106, based on the identification tag that is multiplexed with the base content, content metadata, and/or object.

At step 512, the content is modified, based on the dynamic content and the user profile. The content server 104 receives the preferences of a user that corresponds to the different attributes of the dynamic content. For example, if a user is from a medium-income segment, the content provided can be modified, based on the preferences of the user, by including items that are priced below a threshold limit.

At step 514, the content server 104 notifies the modifications in the content to the content creator 102. The content creator 102 decides whether to include the modifications in the content. For example, the content creator 102 can send a confirmation for the changes made by the content sever 104. In one embodiment, the content server 104 suggests modifications to the content creator 102. These suggestions can include modifications, based on the user profile. The modifications can correspond to the different attributes of the content, based on the preferences of the user. For example, when the content server 104 suggests including a monument in the background of an advertisement, the content creator 102 can also suggest including a local character, in addition to the monument in the background.

At step 602, an indication message is received by the content server 104. This indication message includes an acceptance, a rejection or suggestions corresponding to the modifications. The content creator 102 can send the indication message for each modification of the content. The indication message can include confirmation or suggestion information. For example, the content creator 102 can accept a translation of the audio content in a new language and can reject the translation of the video content. In one embodiment, the indication message includes modified dynamic content, which is modified by the content creator 102, based on the suggestions made by the content server 104. In another example, the content creator 102 can also suggest modifications to the content server 104, based on the suggestions made by the content server 104.

At step 604, the content is delivered to the user equipment 108 by the transmitting module 204 in the content server 104. This content includes the base content and the dynamic content. The method is terminated at step 606.

Various embodiments, as described above, provide a method and content server for managing content in a network. The present invention modifies the content, based on a user profile. This helps a user to identify with the content, since it is based on the user profile or preferences. As a result, the content becomes more acceptable to the user. Further, there is no need to create entirely different content or advertisements for different demographics, and the existing content can be modified for different users in different locations. The content is modified, based on the user profile, and includes local customs, culture and knowledge, which results in the effective delivery of the content.

In the foregoing specification, the invention and its benefits and advantages have been described with reference to specific embodiments. However, one with ordinary skill in the art would appreciate that various modifications and changes can be made, without departing from the scope of the present invention, as set forth in the following claims. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application and all equivalents of those claims, as issued.

What is claimed is:

1. A method for managing content in a network, the network comprising a content server, the method at the content server comprising:
receiving a base content of the content, wherein the base content includes information independent of a user profile; and
modifying the content based on a dynamic content of the content, the base content and the user profile.

2. The method as recited in claim 1 further comprising receiving attributes of the dynamic content from a content creator in the network.

3. The method as recited in claim 1 further comprising receiving the user profile from at least one of a demographic information portal, a third party portal and a social networking site.

4. The method as recited in claim 3, wherein receiving the user profile is based on at least one of an object, a portion, a scene, an attribute, and a frame coordinate of the content.

5. The method as recited in claim 1 further comprising:
notifying the modifications in the content to a content creator; and
receiving an indication message from the content creator based on the modifications, wherein the indication message comprises at least one of a confirmation and a suggestion information.

6. The method as recited in claim 1 further comprising providing the content to a user equipment in the network.

7. The method as recited in claim 6, wherein the user equipment is at least one of a television, an Internet Protocol Television (IPTV), a computer, a set-top-box, a mobile phone, a music player, and a radio set.

8. The method as recited in claim 1, wherein the content is at least one of a commercial message, an advertisement, a trade related information, current program information, future program information, a display logo, a subtitle, audio information, a channel logo, a ticker and a flash display.

9. The method as recited in claim 1, wherein the user profile is based on at least one of preference of the user, geographical location of the user, age of the user, sex of the user, social network of the user, community of the user, religion of the user, job sector of the user, and historical data of the user.

10. A method for managing content in a network, the network comprising a content server, the method at the content server comprising:
receiving the content, the content comprising a base content and a dynamic content; and
modifying the content based on the dynamic content and a user profile.

11. The method as recited in claim 10 further comprising receiving attributes of the dynamic content of the content from a content creator.

12. The method as recited in claim 10 further comprising identifying the dynamic content of the content based on at least one of an object, a portion, a scene, an attribute, and a frame coordinate of the content.

13. The method as recited in claim 10 further comprising receiving the user profile from at least one of a demographic information portal, a third party portal and a social networking site.

14. The method as recited in claim 10 further comprising:
notifying the modifications in the content based on the dynamic content and the user profile to a content creator; and
receiving an indication message from the content creator based on the modifications, wherein the indication message comprises at least one of a confirmation and suggestion information.

15. The method as recited in claim 10 further comprising suggesting modifications in the content based on the user profile to a content creator.

16. A content server for managing content in a network, the content server comprising:
a receiving module configured to receive the content; and
a processing module configured to modify the content based on a dynamic content of the content and a user profile.

17. The content server as recited in claim 16, wherein the processing module is further configured to identify the dynamic content of the content.

18. The content server as recited in claim 17, wherein the processing module identifies the dynamic content based on at least one of an object, a portion, a scene, an attribute, and a frame coordinate in the content.

19. The content server as recited in claim 16 further comprising a transmitting module, wherein the transmitting module is configured to provide the content to a user equipment in the network.

20. The content server as recited in claim 16, wherein the content server is selected from the group comprising a satellite station, a broadcast station, a base station, an head-end device, and a radio station.
